(19) United States
(12) Patent Application Publication
(10) Pub. No.: US 2003/0035619 A1
(43) Pub. Date: Feb. 20, 2003

(54) Cascaded optical filters

(75) Inventor: Thomas Pfeiffer, Stuttgart (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/196,422

(22) Filed: Jul. 17, 2002

(30) Foreign Application Priority Data
Aug. 20, 2001 (EP) 01 440 273.9

(51) Int. Cl. G02B 6/26; G02B 5/20

(52) U.S. Cl. 385/27; 385/15; 359/890

(57) ABSTRACT

It is an objective of the invention to reduce the technical complexity involved in the implementation of optical filters used in particular for the encoding and decoding of OCDM signals. It is also intended to simplify the tuning in order, on the one hand, to make the selection of the required transmission channels as simple as possible and, on the other, to be able at the receiving end to regulate the optical filter drift at the transmitting end for optimum reception. This object is achieved by an optical filter arrangement containing a first optical filter and a second optical filter connected in series or in parallel and with the second optical filter having an FSR adjustment range differing from the FSR adjustment range of the first filter. An advantageous effect is that the second optical filter facilitates fine tuning, with in particular the readjustment at the receiving end of optical filter drifts at the transmitting end being simplified.

### TECHNICAL FIELD

The invention relates to an optical filter arrangement. The invention is based on a priority application EP 01 440 273.9 which is hereby incorporated by reference.

### BACKGROUND OF THE INVENTION

Optical filters are used in optical systems, for example, for encoding and decoding optical signals, for example with OCDM, which is also known as OCDMA; OCDM=optical code division multiplex, OCDMA=optical code division multiplex access. OCDM is based on the spectral encoding of broadband optical sources. The light from an LED modulated with data to be transmitted is guided through an optical filter for example and encoded in this way; LED =light emitting diode. Several of these LEDs and optical filter combinations are connected at the transmitting end by an optical coupler, for example, to an EDFA, which is connected to an optical fibre line; EDFA=erbium doped fibre amplifier. In this way, differently encoded optical signals are generated and transmitted jointly amplified via the optical fibres. An optical splitter enables them to be transmitted to several receiving ends. Every receiving end contains, for example, a differential receiver with a corresponding optical filter for the decoding of the optical signals determined for the receiving side.

An optical filter may be implemented as a Mach-Zehnder filter for example. In the Mach-Zehnder filter, the OCDM signal received is relayed via two paths with complementary transmission functions. The Mach-Zehnder filter may be used for both the encoding and decoding of OCDM signals.

At the transmitting end, one optical filter is used for each optical transmission channel for example. The optical filters must be well tuned to each other in order, for example, to reduce crosstalk. At the receiving side an optical filter is used, for example, which is aligned with the optical transmission channel provided for the receiving end. Alternatively, the same number of optical filters is used at the receiving end for example as at the transmitting end. The optical filters at the receiving side are tuned to the optical filters at the transmitting end.

### SUMMARY OF THE INVENTION

It is an object of the invention to reduce the technical complexity involved in the implementation of optical filters. It is also intended to simplify the tuning in order, on the one hand, to make the selection of the required transmission channels as simple as possible and, on the other, to be able at the receiving end to regulate the optical filter drift at the transmitting end for optimum reception.

This object is achieved by an optical filter arrangement containing a first optical filter and a second optical filter connected in series or in parallel and with the second optical filter having an FSR adjustment range differing from the FSR adjustment range of the first filter.

An advantageous effect is that the second optical filter facilitates fine tuning, with in particular the readjustment at the receiving end of optical filter drifts at the transmitting end being simplified.

In addition, in an optical system, overall fewer different optical filter types are required for the generation of a prespecified number of optical transmission channels. Compared to the prior art, significantly more optical transmission channels can be generated with the same number of optical filters. In addition, complex spectra can be generated simply.

The optical filter arrangement can be placed on a hybrid opto-electronic integrated circuit and in this way be used in a extremely space-saving way.

In an advantageous development, the FSR adjustment ranges of the first and second optical filters differ by at least a factor of ten. The first optical filter is implemented as a Mach-Zehnder filter or AWG for example and the second optical filter is implemented as a Mach-Zehnder filter or AWG for example; AWG=arrayed waveguide grating.

In another preferred development, at least a third optical filter is connected in series or in parallel to the first or second optical filter. The FSR adjustment range of the (at least) third optical filter may be the some as or different from the FSR adjustment range of the first or second optical filter. The number of optical transmission channels can be increased. The encoding can be performed with fewer filters and the re-adjustment by fine tuning is simplified. The FSR adjustment range of the first, second and third optical filters differ from each other by at least a factor of ten, for example.

In another advantageous development of the invention, the first and second optical filters are connected in parallel and the filter functions of the second filter are integrated in the first filter. In this way, new components, for example, can be generated, for example an AWG containing at least three optical branches connected in parallel, with each optical branch having a different FSR adjustment range. The optical branches are implemented as optical delay lines for example, with every delay line having a different delay time value.

The first and second optical filters are both implemented, for example, as filters with periodic transmission functions, FIR filters for example. When assembling an optical system, at least one optical transmitting device containing at least one optical filter arrangement according to the invention for the encoding of optical signals can be used at the transmitting end. The use of a large number of optical filter arrangements according to the invention at the transmitting end which are connected in parallel and whose outputs are connected by at least one optical combiner for the purpose of transmitting the superposed signal via an optical fibre line enables numerous encoded signals to be generated which can be transmitted simultaneously.

Similarly, when assembling an optical system at the receiving end, at least one optical receiving device containing at least one optical filter arrangement according to the invention for the decoding of optical signals can be used. The use of a large number of optical filter arrangements according to the invention at the receiving end, which are connected in parallel and whose inputs are connected via at least one optical splitter for the purposes of receiving a superposed optical signal via an optical fibre line enables a large number of signals to be decoded simultaneously.

### BRIEF DESCRIPTION OF THE DRAWINGS

Advantageous developments should be taken from the dependent claims and the following description.

The following explains the invention using two examples of embodiments using six drawings. These show:

FIG. 1 A schematic representation of a first optical filter arrangement according to the invention

FIG. 2 A numerical simulation of a composite transmission function for the optical filter arrangement in FIG. 1

FIG. 3 Another numerical simulation of a composite transmission function for the optical filter arrangement in FIG. 1

FIG. 4 A schematic representation of a second optical filter arrangement according to the invention

FIG. 5 A numerical simulation of a composite transmission function for the optical filter arrangement in FIG. 4

FIG. 6 Another numerical simulation of a composite transmission function for the optical filter arrangement in FIG. 4

### BEST MODE FOR CARRYING OUT THE INVENTION

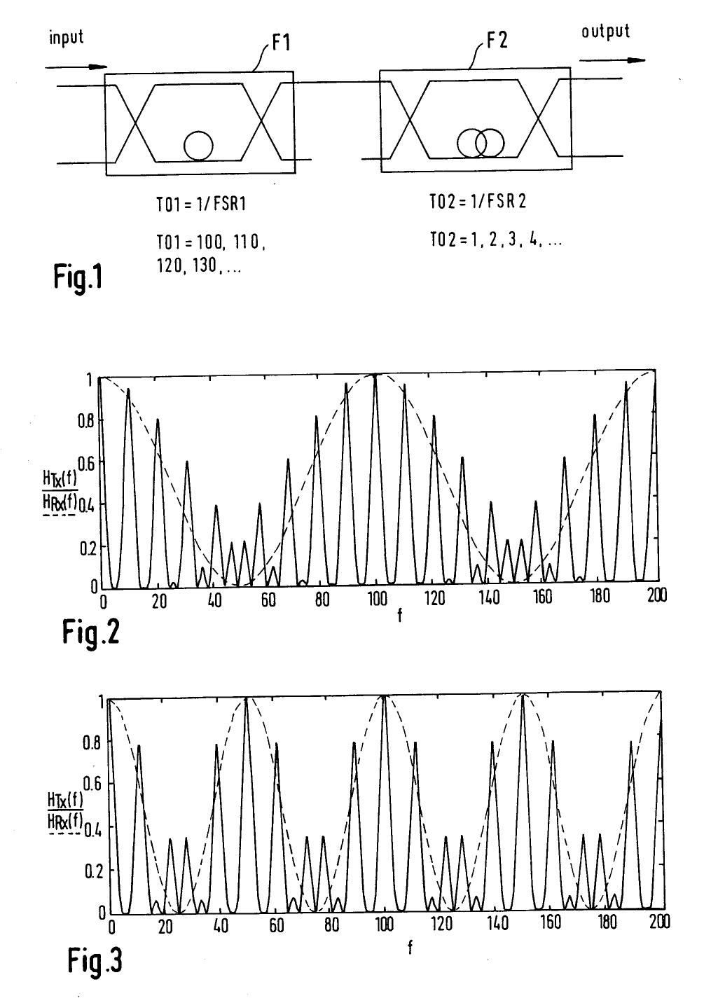

The first example of an embodiment will now be explained using FIG. 1 to FIG. 3.

FIG. 1 shows an optical filter arrangement in accordance with the invention. The optical filter arrangement contains two optical filters cascaded in sequence F1, F2. Both filters, F1, F2 are implemented as Mach-Zehnder filters, for example. Filter F1 has an FSR adjustment range which differs from the FSR adjustment range of filter F2; FSR free spectral range. FSR is defined over the period T0=1/FSR. For filter F1, T01=1/FSR1, for filter 2, T02=1/FSR2.

The optical filters F1 and F2 are, for example, both implemented as filters with periodic transmission functions, FIR or IIR filters. A filter has a transmission function H(v) equal to:

$$H ( v ) = \frac{1}{2} \{ 1 + cos [ 2 π {vT}_{0} ] \}$$

T0 may be used to set the FSR adjustment range and hence the optical transmission channel.

When the optical filters F1 and F2 are connected, the composite transmission function H(v)=H_{T01}(v)×H_{T02}(v) is equal to:

$$H ( v ) = \frac{1}{4} \{ 1 + cos [ 2 π {vT}_{01} ] + cos [ 2 π {vT}_{02} ] + \frac{1}{2} cos [ 2 π v ( {T}_{01} - {T}_{02} ) ] + \frac{1}{2} cos [ 2 π v ( {T}_{01} + {T}_{02} ) ] \}$$

Each of the cosine terms may in principle be used for the encoding and decoding, alone or in combination. As a result, the following terms:

T01, T02, T01−T02 and T01-T02

are available for encoding and decoding.

When using T01−T02, even small changes to one quantity may have large impacts on the overall quantity, for example

T01=100 ps, T02=90 PS, T01−T02=10 ps,

a change to T01 by 10% upwards results in T01−T02=20 ps, signifying a change of 100%.

When using T01+T02, filters with a very different FSR are used, for example, eg T01=100, 120, 140, 160 etc ps and T02=12, 14, 16, 18 etc ps. This enables optical transmission codes to be formed based on the sum of T01+T02 and may have the following values:

T01+T02=112, 114, 116, etc, 132, 134, 136, etc ps.

At the transmitting end, then for example, two Mach-Zehnder filters connected in series are used and at the receiving end, one Mach-Zehnder filter.

The connection of the two filters F1 and F2 now gives rise to numerous possible combinations. Numerous optical transmission channels may be generated.

For filter F1, for example, T01=100, 1 10, 120, 130 etc.

For filter F2, for example, T02=1, 2, 3, 4, 5 etc.

Example for T0 combined=101, 102, 103, etc 109, 110, 111, 112, etc, 131, 132, etc.

If, for example, ten periods per filter may be set, the use of two independent filters enables twenty periods and hence twenty transmission channels to be generated. Using the interconnection of two filters according to the invention, ten times ten equal to one hundred transmission channels may be generated. This corresponds to a quintuplication of the transmission channels generated.

In addition, the use of two independent filters, eg to generate twenty transmission channels in the range from T0=100 to 290 in steps of ten, in particular complicates readjustment. The use of the interconnection of two filters according to the invention in particular permits fine tuning by means of the second filter. When, for example, twenty transmission channels are generated in the range from T0=100 to 190 in steps of 5, readjustment is possible in a simple way with the second filter, eg in steps of one.

The optical filters F1 and F2 may be used both for the encoding and for the decoding and hence both at the transmitting end and the receiving end.

FIG. 2 shows a numerical simulation of a composite transmission function for the optical filter arrangement in FIG. 1. The frequency in GHz is plotted on the X-axis and the transmission function H_{TX}(f) as a solid line and the transmission function H_{RX(f)} as a dotted line.

The transmission function H_{TX}(f) is the composite transmission function.

The transmission function H_{RX(f)} is the part of the composite function used for the encoding, ie, eg T₀ref=T₀₁−T02.

The following parameters are selected:

TO₁₌₁₀₀ ps, T02=90 ps.

T₀ref=10 ps.

FIG. 3 shows another numerical simulation of a composite transmission function for the optical filter arrangement in FIG. 1. The frequency in GHz is plotted on the X-axis and the transmission function H_{TX}(f) as a solid line and the transmission function H_{RX(f)} as a dotted line on the Y-axis

The transmission function H_{TX}(f) is the composite transmission function.

The transmission function H_{RX(f)} is the part of the composite function used for the encoding, ie, eg T₀ref=T01−T02.

The following parameters are selected:

T01=100 ps, T02=80 ps.

T₀ref=20 Ps.

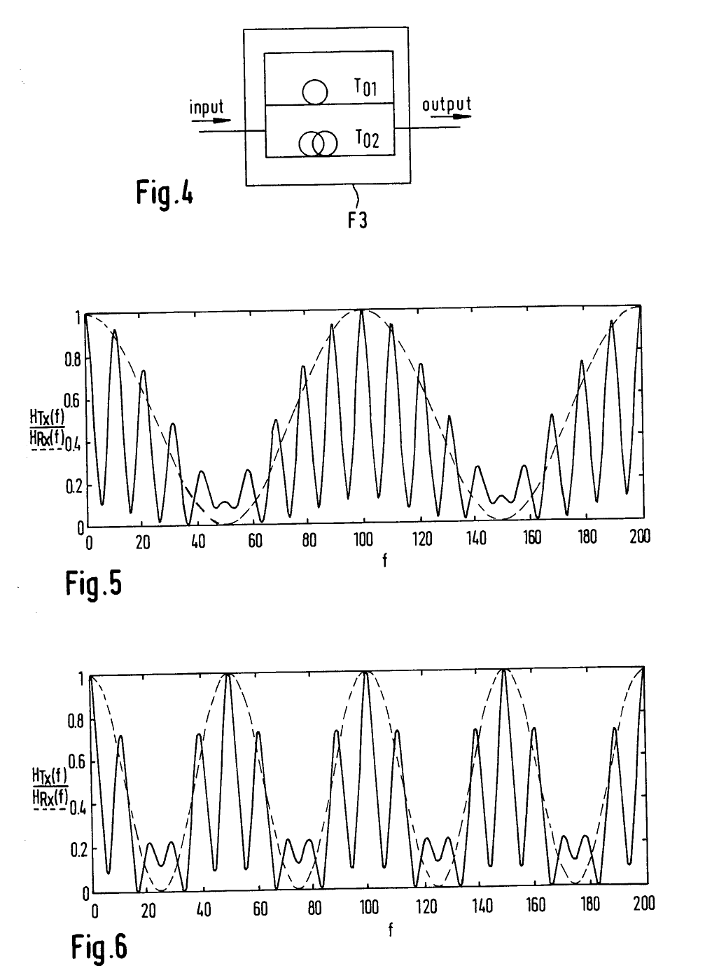

The second example of an embodiment will now be explained using the help of FIG. 4 to FIG. 6. FIG. 4 shows an optical filter arrangement according to the invention. In the optical filter arrangement F3, a first and a second optical filter are connected in parallel and the filter functions of the second filter are integrated in the first filter. In this way, a new component is generated, for example, an AWG filter containing at least three optical branches connected in parallel, with each optical branch having a different delay value.

The advantages and the selection possibilities of the FSR as described in FIG. 1 are similar in the optical filter arrangement in FIG. 4.

FIG. 5 shows a numerical simulation of a composite transmission function for the optical filter arrangement in FIG. 4. The frequency in GHz is plotted on the X-axis and the transmission function H_{TX}(f) as a solid line and the transmission function H_{RX(f)} as a dotted line on the Y-axis.

The transmission function H_{TX}(f) is the composite transmission function.

The transmission function H_{RX}(f) is the part of the composite function used for the encoding, ie, eg T0ref=T01−T02.

The following parameters are selected:

T0=100 ps, T02=90 ps.

T0ref=10 ps.

FIG. 6 shows a numerical simulation of a composite transmission function for the optical filter arrangement in FIG. 4. The frequency in GHz is plotted on the X-axis and the transmission function H_{RX}(f) as a solid line and the transmission function H_{RX(f)} as a dotted line on the Y-axis.

The transmission function H_{RX}(f) is the composite transmission function.

The transmission function H_{RX(f)} is the part of the composite function used for the encoding, ie, eg T0ref=T01−T02.

The following parameters are selected:

T01=100 ps, T02=80 ps.

T0ref=20 ps.

In both examples of embodiments, the number of filters or at least the filter functions in an optical filter arrangement according to the invention is equal to two. In place of two optical filters, in the optical filter arrangement according to the invention, it is also possible for three or more optical filters to be connected in series or three or more optical filters to be connected in parallel. In an optical filter arrangement according to the invention, four or more parallel branches may be provided to implement three or more functions. Combinations of series and parallel connections of optical filters and/or filter functions are possible. For example, several Mach-Zehnder filters and AWG filters may be interconnected in a combined series/parallel configuration. Mach-Zehnder filters and AWG filters may also be combined with IIR filters, e.g. Fabry-Perot filters.

1. An optical filter arrangement containing a first optical filter and a second optical filter which are connected in series or in parallel and with the second optical filter having an FSR adjustment range different from the FSR adjustment range of the first filter.

2. An optical filter arrangement according to claim 1, wherein the FSR adjustment ranges of the first and second optical filters differ from each other by a factor of at least ten.

3. An optical filter arrangement according to claim 1, wherein the first optical filter is implemented as a Mach-Zehnder filter or as an AWG filter and that the second optical filter is implemented as a Mach-Zehnder filter or as an AWG filter.

4. An optical filter arrangement according to claim 1, wherein at least a third optical filter is connected in series or in parallel to the first or the second optical filter.

5. An optical filter arrangement according to claim 1, wherein the first and second optical filter are connected in parallel and that the filter functions of the second filter are integrated in the first filter.

6. An optical filter arrangement according to claim 1, wherein the first and second optical filters are each implemented as a filter with a periodic transfer function.

7. An optical transmitting device containing at least one optical filter arrangement for the encoding of optical signals containing a first optical filter and a second optical filter which are connected in series or in parallel and with the second optical filter having an FSR adjustment range different from the FSR adjustment range of the first filter.

8. An optical receiving device containing at least one optical filter arrangement for the decoding of optical signals containing a first optical filter and a second optical filter which are connected in series or in parallel and with the second optical filter having an FSR adjustment range different from the FSR adjustment range of the first filter.

9. An optical OCDM system containing
at least one optical transmitting device for the encoding of optical signals containing at least one optical filter arrangement containing a first optical filter and a second optical filter which are connected in series or in parallel and with the second optical filter having an FSR adjustment range different from the FSR adjustment range of the first filter and
at least one optical receiving device for the decoding of optical signals containing at least one optical filter arrangement containing a first optical filter and a second optical filter which are connected in series or in parallel and with the second optical filter having an FSR adjustment range different from the FSR adjustment range of the first filter,
which are connected to each other via optical transmission lines.

10. An optical filter arrangement, in particular an AWG filter containing at least three optical branches connected in parallel, with each optical branch having a different delay value.
